(19) United States
(12) Patent Application Publication
(10) Pub. No.: US 2023/0186350 A1
(43) Pub. Date: Jun. 15, 2023

(54) TIMEPOST SYSTEM AND METHOD FOR ADVERTISING VIA BLOCKCHAIN AND DISTRIBUTED LEDGER NETWORKS

(71) Applicant: NAHOUNOU INVESTMENT GROUP, LLC, Bristol, CT (US)

(72) Inventor: MICHAEL CHARLES NAHOUNOU, Bloomfield, CT (US)

(73) Assignee: NAHOUNOU INVESTMENT GROUP, LLC, Bristol, CT (US)

(21) Appl. No.: 17/643,843

(22) Filed: Dec. 13, 2021

(51) Int. Cl. G06Q 30/02

(52) U.S. Cl. CPC G06Q 30/0272; G06Q 30/0273; G06Q 30/0277; G06Q 30/0261

(57) ABSTRACT

The present invention relates to a method of displaying an advertisement using a blockchain-based application. The application is stored or installed in a computing device of a user, and communicates with a blockchain framework via a communication network. The application includes a programming code that allows the user to search and select a preferred time slot out of the plurality of time slots. The plurality of time slots is provided in the smart contracts in the form of cryptocurrency. The blockchain framework further includes a server comprising a receiving unit that receives the input feed from the user, a calculation unit that calculates the cost of a selected time slot based on code assigned to the particular time slot, and a display unit for displaying the advertisement when the conditions of the smart contract are fulfilled.

### FIELD OF THE INVENTION

This invention relates to the field of advertising systems and methods and, more particularly, to a novel system and method for advertising an advertisement by a user using a blockchain framework in a communication network.

### BACKGROUND

In the competitive field of Digital Out-Of-Home (DOOH) advertising, small start-up companies often suffer hardship when competing with larger, wealthier companies. The present invention serves to systematically level the playing field to allow for more affordable and equitable DOOH advertising for anyone desiring to advertise.

There is a need for a system and method to allow anyone access to affordable advertisement space and specify the duration and date of a particular advertisement with cost tied. The claimed invention maintains the freshness of exhibited advertisements by limiting the number of times a particular advertisement is displayed per period. The claimed method also allows anyone to schedule advertisements for a fixed cost per duration limited by maximum purchase durations. These features help fulfill needs in the competitive field of advertising.

The current process described in Prior Art assumed a database infrastructure built on centralized storehouses. However, the centralized nature of this antiquated business model does not significantly decrease the probability of a coordinated, centralized attack on the servers operating and managing our data storehouses.

There is a need for a robust system that automates the process of buying of time-slots for users. Blockchain technology plays a huge role in improving the efficiency, security, and optimization of the TimePost System. The technology enables automation of the system, removes the need for central control, and enhances storage capacity by making the platform more secure. Additionally, it improves access to advertising for smaller players by making the process more transparent, open, and ensuring all entries are immutable.

Technological developments surrounding the nucleus of the TimePost system and method for advertising invention have provided a significant opportunity to strengthen the business model's fortification process. Specifically, Blockchain and other Distributed Ledger Technologies (DLTs) have allowed for dramatic improvements to the storage ability of transactional data directly and indirectly derived from events on our system. The data gets recorded as a “container of value” then gets distributed across a decentralized network. As a result, data can be generated and collected during advertisement campaigns, such as analytics and other performance metrics, and gets recorded on immutable, transparent, and virtually tamper-proof blockchain networks.

### SUMMARY OF THE INVENTION

According to an aspect of the present invention, there is provided a method for displaying an advertisement on a display unit using an application stored in a computing device which is operated by a user, wherein said application is in communication with a blockchain framework via a communication network, the method comprising the steps of accessing the blockchain framework by creating an account in said application, receiving an input from the user via the application, wherein the input includes a set of information related to the said advertisement, searching a preferred time slot provided in a coded form in a smart contract for displaying the advertisement, wherein the smart contract is stored in the blockchain framework and comprising a plurality of time slots in a form of ‘tic’ and ‘toc’, selecting the preferred time slot out of the plurality of time slots when it is available for booking, if already booked then application provides a list of alternate time slots which are available for booking; calculating a cost of the preferred time slot via a calculation unit provided within said blockchain framework, paying the cost of the preferred time slot in a form of virtual currency and fiat currency, validating a payment through a plurality of nodes of a blockchain of the blockchain framework, displaying the advertisement on the display unit when a plurality of conditions of said smart contract is fulfilled by an owner of the display unit and the user of the computing device, and monitoring the advertisement in real-time via said application running on the computing device, wherein said application is communicably coupled to a server includes a receiving unit for receiving the input from the user, and the blockchain framework for booking a time slot for advertisement

In an aspect of the present invention, the computing device of the user includes a smartphone, notebook, tablet, laptop, personal computer (PC), personal digital assistant (PDA), and the like.

In an aspect of the present invention, the ‘tic’ refers to the advertisement on a given digital advertising medium for a specific duration, and ‘toc’ refers to one complete set of advertisements that fill a durational period.

In an aspect of the present invention, the set of information includes size, duration, format, quality, and the like of the advertisement.

In an aspect of the present invention, the plurality of time slots is coded in cryptocurrency.

In an aspect of the present invention, said plurality of nodes includes digital property owners, purchasers, sellers, and the like.

In an aspect of the present invention, the calculation unit provides a unique address to the user for the payment of the selected time slot, and this unique address can accept the payment in the form of virtual currency as well as fiat currency.

In an aspect of the present invention, the application allows the user to set the rules/requirement including Geographic address, target audience, age group, target platform, and the like for the advertisement.

In an aspect of the present invention, the application includes a programming code that allows the user to select at least one display unit for displaying the advertisement and modifies a media file of the advertisement in accordance with the display unit.

In an aspect of the present invention, the programming code allows the user to specify geographic locale or locales of the display unit.

In an aspect of the present invention, the programming code allows the advertisement to be transmitted from the computing device of said user to said server.

In an aspect of the present invention, the programming code generates map coordinates of said geographic locale or locales of said display unit.

In an aspect of the present invention, the programming code displays an image of geographic locale or locales with map coordinates to said user.

According to another aspect of the present invention, there is provided a non-transitory computer-readable medium having computer-executable program instructions which, when executed by a computing device with one or more processors, cause said computing device to perform a plurality of instructions including receiving input feed from a user, searching a preferred time slot for displaying an advertisement, selecting the preferred time slot out of a plurality of time slots, suggesting an alternative time slot when said preferred time slot is not available, calculating a cost for the selected time slot which is booked by the user, validating a payment through a plurality of nodes in a network and monitoring the advertisement in real-time.

These and other features, aspects and advantages of the present invention will become better understood with reference to the following drawings, descriptions, and claims.

### BRIEF DESCRIPTION OF THE DRAWINGS

The advantages and features of the present invention will become better understood with reference to the following detailed description taken in conjunction with the accompanying drawings, in which:

FIG. 1 illustrates a block diagram depicting the timepost system and method for advertising via blockchain and distributed ledger networks, according to an embodiment of the present invention;

FIG. 2 illustrates a flowchart demonstrating a method of displaying an advertisement using an application, in accordance with an embodiment of the present invention;

FIG. 3 represents a flowchart demonstrating the signup of the user into the Timepost app, according to various embodiments of the present invention;

FIG. 4 represents a flowchart demonstrating the method, according to various embodiments of the present invention;

FIG. 5 represents a flowchart demonstrating the operation of a preferred embodiment of the claimed method, according to various embodiments of the present invention;

FIG. 6 is a continuation of the flowchart represented in FIG. 5, according to various embodiments of the present invention;

FIG. 7 is a continuation of the flowchart represented in FIG. 6, according to various embodiments of the present invention;

FIG. 8 represents a structural configuration of the user computing device, according to various embodiments of the present invention; and

FIG. 9 is a block diagram illustrating the various rewards, benefits for the user, according to various embodiments of the present invention.

Like reference numerals refer to like parts throughout the description of several views of the drawing.

### DESCRIPTION OF THE INVENTION

The exemplary embodiments described herein for illustrative purposes are subject to many variations in structure and design. It should be emphasized, however, that the present invention is not limited to a system and method which relate to advertising an advertisement by a user using blockchain framework in a communication network. It is understood that various omissions and substitutions of equivalents are contemplated as circumstances may suggest or render expedient, but these are intended to cover the application or implementation without departing from the spirit or scope of the present invention.

The terms “a” and “an” herein do not denote a limitation of quantity, but rather denote the presence of at least one of the referenced items.

The terms “having”, “comprising”, “including”, and variations thereof signify the presence of a component.

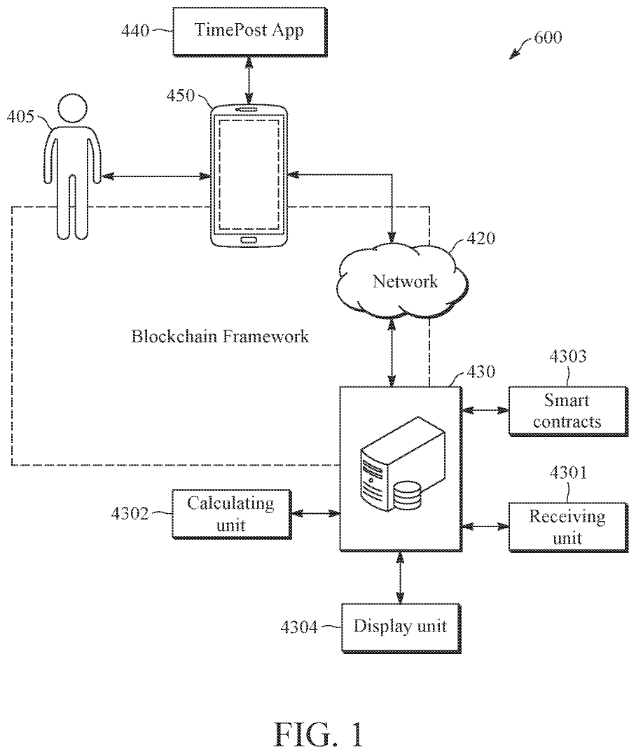

FIG. 1 illustrates an exemplary system architecture 600, in accordance with one implementation of the disclosure. The system architecture 600 includes a computing device 450 being operated by a user 405, a communication network 420, and a server 430. In one implementation, the communication network 420 may include a public network (e.g., the Internet), a private network (e.g., a local area network (LAN) or wide area network (WAN)), a wired network (e.g., Ethernet network), a wireless network (e.g., an 802.1 1 network or a Wi-Fi network), a cellular network (e.g., a Long Term Evolution (LTE) network), routers, hubs, switches, server computers, and/or a combination thereof. In one implementation, the user computing device may be one or more computing devices (such as a personal computer, a mainframe computer, a laptop computer, a tablet computer, a desktop computer, etc.), data stores (e.g., hard disks, memories, databases), networks, software components, and/or hardware components that may be used to provide a user with access to media items and/or provide the media items to the user. For example, the Timepost application 440 may allow a user to upload advertisements.

The present system includes a Blockchain framework. It will be apparent to a person skilled in the art that blockchain is a growing list of records, called blocks, that are linked together using cryptography. Each block contains a cryptographic hash of the previous block, a timestamp, and transaction data. The timestamp proves that the transaction data existed when the block was published in order to get into its hash. As blocks each contain information about the block previous to it, they form a chain, with each additional block reinforcing the ones before it. Therefore, blockchains are resistant to modification of their data because once recorded, the data in any given block cannot be altered retroactively without altering all subsequent blocks. The infrastructure such that our storehouses can now be programmed and built on a decentralized architecture, using private and public blockchains and/or other DLTs. Several advantages are there, which improve current centralized systems, including increased security for every TIC and TOC sold on our platform. It is now virtually impossible for the storehouses to suffer from any single point of failure attack, and their advertisements can be posted with increasing confidence. Perhaps the most compelling and advantageous benefit of the addition of this new “trust layer” in the system is the creation, control, and distribution of our TIC TOCs as a digital token or cryptocurrency (crypto). Users can now benefit from the option of exchanging their TIC TOCs into any existing crypto or fiat currency.

In order to explain the invention further, there is provided a server 430, which is communicably coupled to the user's computing device 450 and includes various features such as Receiving unit 4301, Calculation unit 4302, Smart Contracts 4303, Display unit 4304. For the sake of brevity, a further configuration of the server is omitted here in the description.

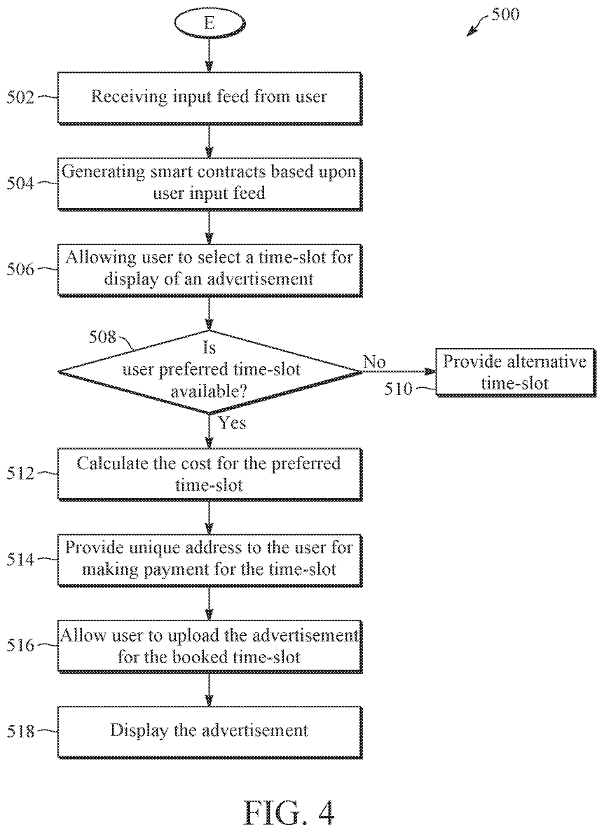

The Receiving unit 4301 is configured to receive the input feed from the user 405. A blockchain of the said blockchain framework is provided. Said blockchain is configured to include the virtual currency, storage, and smart contracts 4303. The smart contracts 4303 are generated based on the input feed of the user 405 for including the rules, user preferences, etc., for displaying the advertisements. The smart contracts 4303 allow the user 405 to choose at least one time slot from the plurality of time slots. The smart contracts 4303 and the rules shall be explained with respect to FIGS. 4-6.

Further, there is provided a calculation unit 4302 for calculating the cost of the time slot/token based upon input feed by the user 405.

The claimed invention is a method for advertisement that embodies a blockchain in a blockchain framework. This detailed description sets out the best mode of executing certain embodiments of the claimed invention. Each second, minute, and hour is attributed to a space on the advertising scheme. Accordingly, by the end of the day, each second, minute, and hour may be filled with an advertisement. Users 405 have options for the way in which they want their advertisements to be displayed. During the operation of the claimed invention, user 405 will have the option to change the duration and frequency of the advertisement display. This is accomplished while using the language and attributes of a standard time clock. After a user 405 chooses these fields, the user 405 will receive a competitive rate for the advertising and the same rate that any advertiser would pay for the same duration of advertisement for the given medium chosen.

To accomplish these tasks, the claimed method relies on complex algorithms and a processor to execute user's requests according to those algorithms. In addition, the claimed invention relies on a display platform to fully complete the advertising process. Without any one of the complex algorithms, processors, and display platforms, the method of the claimed invention would not operate.

Advertisements in this system and method are defined as Tics and Tocs. A “Tic” as used herein, is an advertisement on a given digital advertising medium for a specific duration. A “Toc” is one complete set of advertisements that fill a durational period. In one embodiment, four different advertisements by four different advertisers on a given digital advertising medium make up a specific longer duration. Tics may be of different durations but always equal to or shorter in duration than a Toc. The duration of a Toc is equal to the sum of the duration of one or more Tics. In traditional advertisement lingo and in one embodiment herein, a Tic is akin to one advertisement, and a Toc is akin to a two-minute advertisement slot. In this example, two fifteen-second Tics, one thirty-second Tic, and one one-minute Tic could equal a Toc.

Users 405 will be able to conduct a scheduling system by using claimed method-modeled digital signage systems and Internet mediums online. To purchase an advertising slot (Tic or Toc) for mediums using the claimed invention, users 405 can follow the online registration procedures via a website or local specialized Time Post office. At these portals, companies can determine the type of Tic, the frequency of display, or the Calendar Type period. The method of the present invention allows for administrators to process payments online. In one embodiment, a user 405 would be able to start purchasing advertising slots in the month immediately preceding the year, which contains said advertising slots. For example, if a user 405 wanted to purchase the advertising slot of February 2017, he would be able to complete the act of purchasing said advertising slot in December 2016.

The present invention includes smart contracts 4303, which determines availability based on variable duration and frequency of ads, manages user content, and deals with inventory management for each display unit.

In a preferred embodiment, there are 4 Tics in every Toc. Each Toc lasts exactly 120 seconds (2 minutes). A single Toc contains one 60-second Tic, one 30-second Tic, and two 15-second Tics. The four Tics are grouped in Toc [2-minute] intervals. A digital advertising medium utilizing the claimed method can advertise a maximum of 30 Tocs per hour. This extrapolates to 2,880 Tics and 720 Tocs in 24 hours.

Along with the traditional time clock language of “Tic” and “Toc,” this system and method will additionally include similar language to label time intervals. The labels have Whole Minute, Half Past, and Quarter Past. The claimed method uses this traditional language, which usually signifies a given time of the hour, as labels for the various types of Tics or the specific types of advertisements. For example, a “Whole Minute” advertisement is an alternative name for a 60-second Tic. A “Half Past” advertisement is an alternative name for a 30-second Tic. A “Quarter Past” advertisement is an alternative name for a 15-second Tic.

A user can have more than one advertisement instituted in the claimed method. In a preferred embodiment, the present invention maintains the freshness of advertisements by limiting each advertisement to a maximum of 1 minute per hour per day. In an alternative embodiment, the cumulative display time of one advertisement may reach 6 minutes, or 3 Tocs, per hour per day. Thus, with 120 Tics in each hour, up to 120 different businesses can be advertised in one hour in the claimed method. This fulfills a need of freshness in advertising and also serves to level the playing field among businesses desiring to advertise by preventing monopolization due to one user buying up all available Tics and/or Tocs.

The advertising method of the present invention discloses several distinct and surprising advantages from advertising concepts currently known in the art. Currently, standard digital billboards typically display an average of eight advertisers per board per day. Furthermore, the same eight advertisements typically circulate at 8-second intervals every 64 seconds per day. Thus, the shortest available time for an advertisement using the claimed method, 15 seconds, is near twice the duration of the maximum available time on a standard digital billboard [8 seconds]. Furthermore, the maximum available time for an advertisement using the claimed method is an entire minute [60 seconds].

Additionally, the present invention limits advertisers to a purchase of one Tic per hour assuring that no one advertiser may monopolize one advertising medium. In one embodiment, there will be a maximum of 120 different advertisers per hour, achieved when each of the thirty Tocs of one hour features four distinct advertisers purchasing a separate Tic. While this may be against normal sales logic of wanting to sell out as quickly as possible, even if that means selling all time slots to the first taker, the end result is fresh ads with less repetition making them more watched and hence more valuable and more desired by advertisers. Therefore, in one year, a single display unit utilizing the claimed method in one embodiment can display a total of 43,800 advertisers, as compared with 2,920 on a single standard display unit. By keeping the price fixed per duration, any and all advertisers may compete on a level playing field with all other advertisers.

The present invention utilizes a sophisticated scheduling system for organizing all advertisements. Using a process called “Calendar Typing,” in one embodiment, the claimed invention disseminates advertisements at fixed intervals throughout a year. A user 405 may purchase advertisement space using up to six different Calendar Type periods, which include days, weeks, months, quarters, semi-annuals, and years.

In one embodiment of the present invention, each of the six Calendar Type periods signifies the fixed length of time an advertisement campaign will run. For example, a “day” Calendar Type period will run once every hour for up to one day. A “week” Calendar Type period will run once every hour for up to one week. A “month” Calendar Type period will run once every hour for up to one month. A “quarter” Calendar Type period will run once every hour for up to one 3-month period. A “semi-annual” Calendar Type period will run once every hour for up to one 6-month period. A “year” Calendar Type period will run once every hour for up to one year. If a user 405 desires to display an advertisement in a year past the current calendar year, said user 405 will have to purchase advertisement space for a future year or years. If a specified Calendar Type period extends beyond December 31 of a current year, the advertisement will cease running at the start of the new year regardless of the specified Calendar Type period. For example, if a user 405 chooses a “quarter” Calendar Type period to start on November 15, the method of the present invention would preclude the advertisement from running after December 31 even though the selection of a “quarter” Calendar Type would ordinarily instruct the claimed method to display the advertisement for three months.

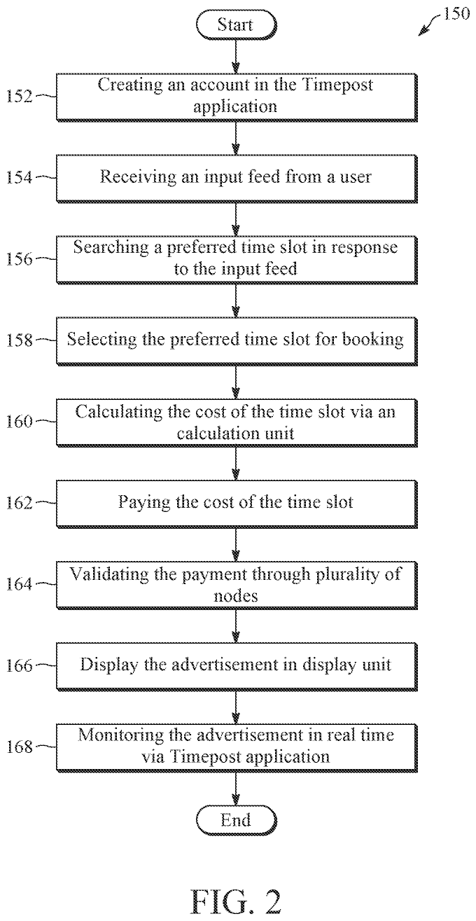

Referring now to FIG. 2 of the present invention illustrating a method 150 for displaying an advertisement using the Timepost application 440 in accordance with an embodiment of the invention. The Timepost application 440 includes a set of computer programs the allows the user 405 to perform particular functions that are necessary for displaying the advertisement. The Timepost application 440 includes a programming code that enables the user to select the display unit on which he wants to display his advertisement. The programing code also allows the user 405 to modify the media file of the advertisement according to the display unit. The programming code of the application also helps in identifying the geographic location of the display unit 4304 and further displays the location with mapping coordinates to the user 405.

The Timepost application 440 can be installed or stored in a computing device 450 of the user 405, wherein the computing device includes but is not limited to a smartphone, notebook, tablet, laptop, personal computer (PC), personal digital assistant (PDA), and the like. The method 150 starts with the first step 152. In first step 152, the user 405 needs to create an account in the Timepost application 440, in order to access the blockchain framework. If the user 405 already has an account in the Timepost application 440, he can directly sign in or log in to the said Timepost application 440. By signing in the Timepost application 440, the user 405 can access the blockchain framework via a communication network 420. Further, the Timepost application 440 is communicably coupled to a server 430 which includes a receiving unit 4301, the blockchain framework comprising a calculation unit 4302, a plurality of smart contracts 4303 etc.

In the next step 154, an input regarding the advertisement is received from the user 405 via the Timepost application 440. The input includes a set of information related to the advertisement, it may include the information about the media file of the advertisement such as format, quality, duration, size, and the like. The user can also set the rules, requirements, and preferences using the Timepost application 440. In this step, the user 405 can also specify the geographical address, target audience, age group, target platform for the advertisement. However, it is not always necessary the user 405 must specify his inputs before searching time slots. In some embodiments, the user can provide his inputs and apply filters after the searching of time slots.

When the input is received from the user 405, then searching for a preferred time slot is performed at step 156. The user's input is received in the receiving unit 4301, then the server 430 provides the plurality of time slots in response to the input feed of the user 405. The time slot is provided in the form of cryptocurrency in a smart contract 4303, wherein smart contracts 4303 are stored in the blockchain framework and are generated based on the input feed of the user 405. The plurality of time slots are provided in the form of ‘tic’ and ‘toe’, wherein ‘tic’ refers to the advertisement on a given digital advertising medium for a specific duration, and ‘toc’ refers to one complete set of advertisements that fills the durational period.

In the next step 158, the user 405 will select the preferred time slot out of the plurality of time slots provided by the server of the blockchain framework. In this step, the user 405 will book the time slot according to his requirements or needs. The user 405 can only book the preferred time slot when it is available for booking. In case, when the preferred time slot is not available for booking, the Timepost application 440 will suggest an alternate time slot for booking. Also, the Timepost application 440 includes a program that limits the booking of multiple time slots by a single user and maintains the freshness of the advertisement by prohibiting the monopoly of top companies or users.

Once the preferred time slot is booked by the user 405, then the cost of the selected time slot is calculated in the next step 160. To perform this task, a calculation unit 4302 is provided in the blockchain framework to calculate the exact cost of the selected time slot. The calculation unit 4302 performs the calculation based on the coded information assigned to the particular time slot, which was booked by the user 405. For calculation purposes, the calculation unit 4302 also employs one or more features of the media file of the advertisement. The features may include the quality, duration, and frequency of the advertisement. In some embodiments, it may include the size and quality of the display unit 4304 at which the advertisement is displayed.

After the calculation of the selected time slot, the user 405 pays the requested amount of the time slot in the step 162. For payment, the calculation unit 4302 provides a unique address to the user 405 via the Timepost application 440. The unique address can accept the payment in the form of virtual currency as well as fiat currency. In some embodiments, the payment can be done through digital currency such as PayPal, ATM or debit card, credit card, and the like. Once the payment is made by the user 405, then it is validated at step 164. In this step, the transactional status of the booked time slot is validated through a plurality of nodes present in the blockchain. The plurality of nodes of the blockchain includes digital property owners, purchasers, sellers, and the like. Each node in the blockchain framework is basically a decentralized digital ledger that records all cryptocurrency transactions and makes the information available to everyone via a connected device.

After payment validation, and when all the conditions of the smart contract 4303 are fulfilled by the owner of the display unit 4304 and the user 405 of the computing device 450, then the advertisement is displayed at the display unit 4304. The advertisement is displayed at step 166. The owner of the display unit 4304 has the full control over files and permissions over sharing, access, editing, etc. The display unit 4304 may include a liquid crystal display (LCD), light-emitting diode (LED) display, Quantum-dot display (QLED), plasma display, organic light-emitting display (OLED), electroluminescent display, and the like. In the final step 168, if a user wants to monitor the advertisement in real-time whether the advertisement is displayed in the selected time slot or not, he can check through Timepost application 440.

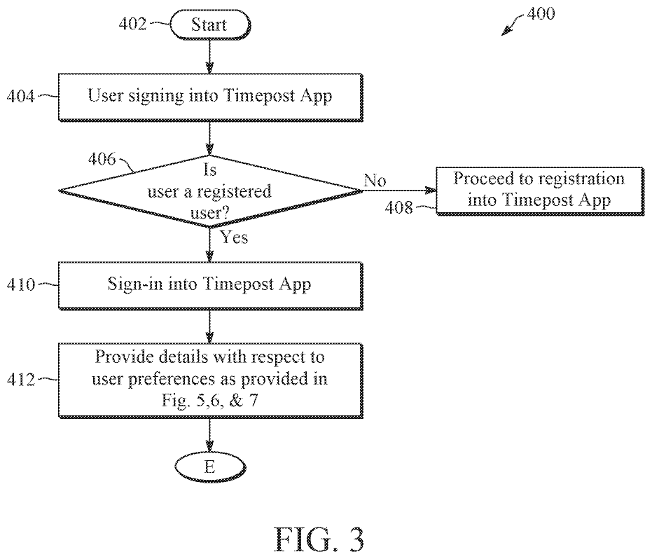

FIG. 3 provides a flowchart for method 400 for registration of the user 405 to Timepost application 440 in accordance with an alternate embodiment. The method starts at 402. At 404, the user 405 signs into the Timepost application 440. The system then checks whether the user 405 is a registered user at step 406. If the user 405 is registered, the system allows the user 405 to sign into the Timepost application 440 at step 410. If the user 405 is not registered, the method moves to step 408 for registering the user 405.

At step 412, the user 405 is required to input various details for buying a time slot for uploading an advertisement to the system.

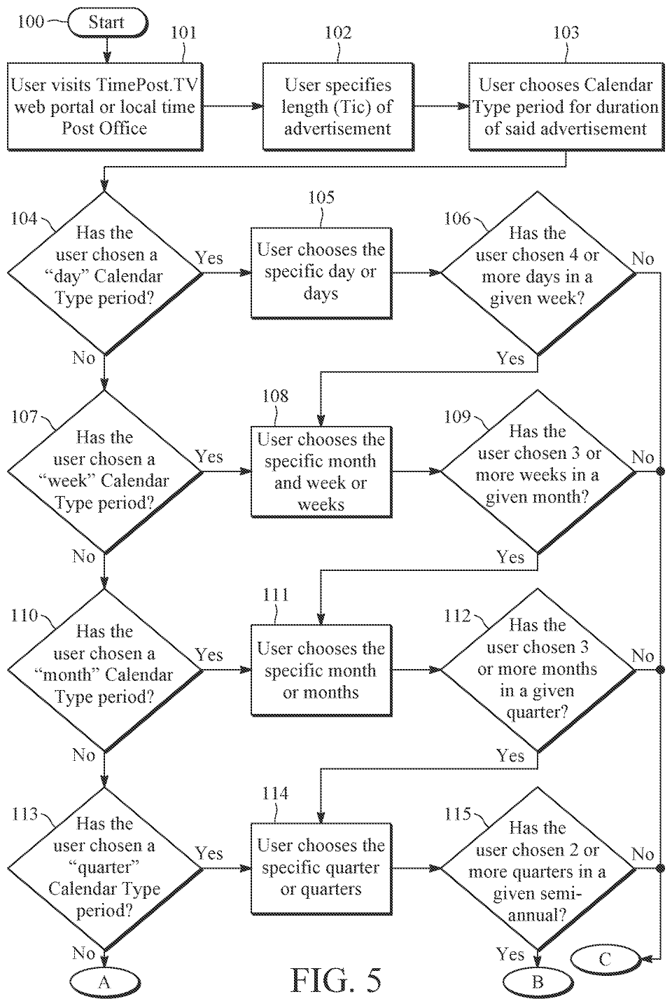

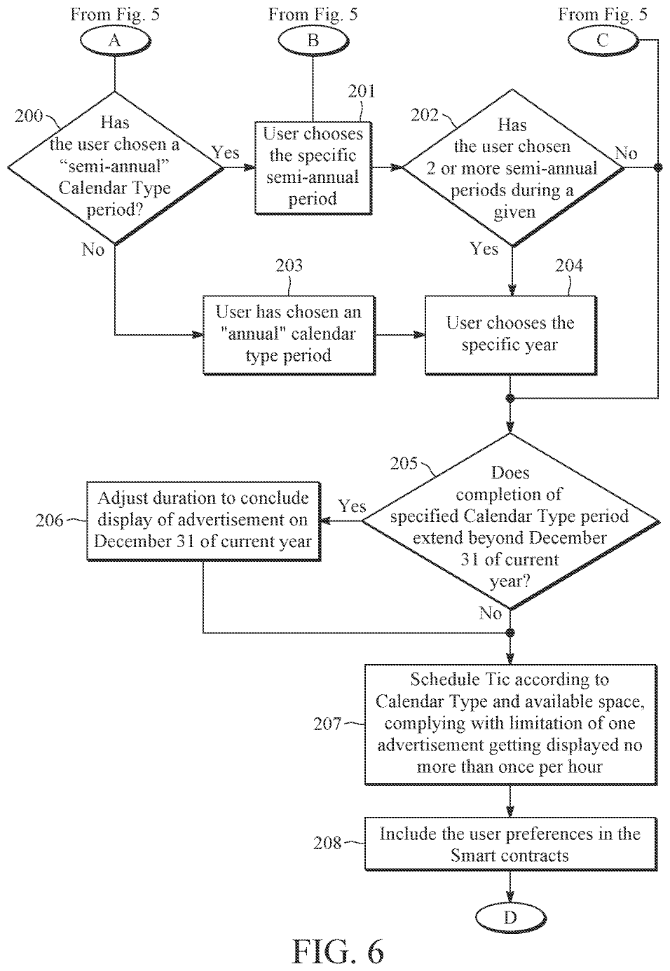

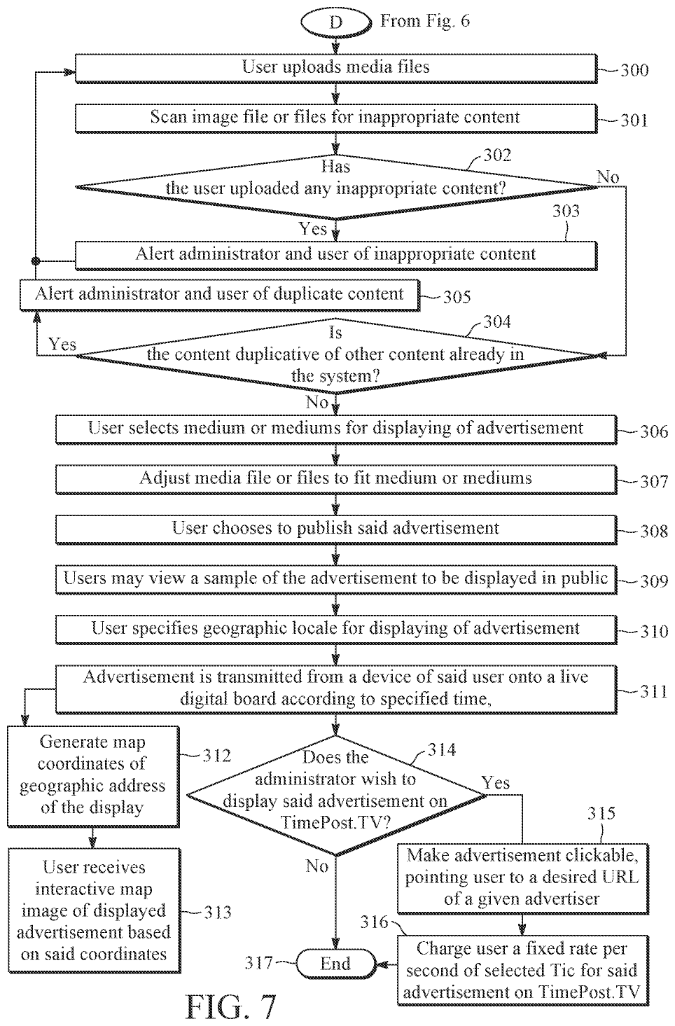

FIG. 5, FIG. 6, and FIG. 7 represent the operation of one embodiment of the claimed method for generation of the smart contracts 4303 based on user 405 input feed at step 412. At the start 100 of the operation, a user 405 must visit 101 a web portal or office or Timepost application 440 and select 102 the length of the Tic. Said user 405 must then choose 103 the frequency of said Tic by specifying a Calendar Type period corresponding to the number of iterations of said advertisement. For example, if an advertiser chooses a 30-second “day” Tic, the advertisement or Tic will appear on a display unit once every hour for 24 hours, lasting 30 seconds each.

For “day” Calendar Type periods 104, the user 405 chooses 105 specific day or days. For “week” Calendar Type periods 107, the user 405 chooses 108 a month and then specific week or weeks. For “month” Calendar Type periods 110, the user 405 chooses 111 specific month or months. For “quarter” Calendar Type periods 113, the user 405 chooses 114 for a specific 3-month period. For “semi-annual” Calendar Type periods 200, the user 405 chooses 201 a specific 6-month period. “Year” Calendar Type periods 203 are available for selection shortly before the intended year. The user 405 chooses 204 a specific year for a “Year” Calendar Type period.

An advertiser may only select one Calendar Type period per advertisement. There are also limitations on purchasing Calendar Type periods. If an advertiser intends to run the same advertisement several times using more than the allowed time limit on the Calendar Type period in question, the advertiser must upgrade to the higher Calendar Type period. For example, if an advertiser wants to run an advertisement using four or more “day” Calendar Type periods during a given week, s/he must upgrade to the “week” Calendar Type period. Therefore, a company is allowed to purchase up to a maximum of three units of the same “day” Calendar Type period for a given week. If a company has reached its maximum allowance and wants to purchase four or more of the same “day” Calendar Type period during a given week, it must upgrade to the higher unit.

The maximum number of units allowed for each Calendar Type period include: three days during a given week for the “day” Calendar Type period 106, two weeks during a given month for the “week” Calendar Type period 109, two months during a given quarter for the “month” Calendar Type period 112, one quarter during a given semi-annual for the “quarter” Calendar Type period 115, and one semi-annual during a given year for the “semi-annual” Calendar Type period 202. Each Calendar Type period is considered a unit of inventory on hand at midnight on January 1 of each year. Therefore, in order to determine whether there is space available for an advertisement, the system and method inspect current inventory. The claimed method checks 205 whether completion of the specified Calendar Type period extends beyond December 31 of a current year. If so, it adjusts 206 duration of display of said advertisement to conclude on December 31 of the current year. The claimed method then schedules 207 the appropriate Tic based on available space and complying with the limitation that the claimed method will display one particular advertisement only once per hour.

The pricing model known in the advertising art using both digital and static mediums is based on the concept of CPM (Cost Per Mille, or cost per thousand), defined as price per 1,000 impressions, or people. This rate is determined by the market and fluctuates depending on the number of people in said market. The CPM is a tool that advertisers and media buyers commonly use to compare different advertising media, leveling the playing field between them. CPM is a measurement of how much a medium costs per 1,000 impressions. Since most advertisers want to make efficient advertising buys, the CPM is the tool used to maximize profits.

By contrast, the pricing model in one embodiment of the claimed method is based on the concept of CPT (Cost Per Tic). CPT is a fixed rate. The claimed method charges 208 users a fixed rate based on based on a cent per second ratio. In one embodiment, each advertisement will cost $0.0333, or 3.33 cents, per second of advertisement time. For example, a 60-second advertisement is priced at the time rate of $0.0333 per second, or $2.00 for the full 60 seconds. The 30-second and 15-second advertisement slots are also priced at the same time rate of $0.0333 per second. This equates to $0.50 CPT total for each 15-second Tic, a $1.00 CPT total for each 30-second Tic, and a $2.00 CPT total for each 60-second Tic. In an alternative embodiment, a multiplier could be applied to the fixed price to account for advertising high-end markets.

The claimed method also generates 209 a Rate Card, which is the total price of what each advertiser pays for a Tic campaign. The calculation depends on the Calendar Type period and the type of Tic. For example, if an advertiser chooses a “Whole Minute” “day” Tic for an advertisement campaign, said advertiser will be paying $48.00 for the said advertisement campaign.

The claimed method also allows administrators to track 210 of available Tics via a daily inventory log. Administrators are also able to keep track 211 of the annual inventory via an annual inventory log. The number of Calendar Type periods sold is categorized by type of Tic. The administrators will be able to determine, for example, how many 60-second “day” Calendar Type periods are available for the year or how many 15-second “quarter” Calendar Type periods are sold for the year. The administrators can use the logs to determine 212 the amount of revenue generated per day and per year.

After a user 405 uploads 300 a media file or files as part of an advertisement to be displayed, the claimed method allows 301 for content-proofing to ensure only appropriate material is published. The claimed method includes an image-filtering component integrated with algorithms and proxy servers to scan 302 images for inappropriate content, spyware, and malware. An administrator can also scan the images for inappropriate content. The claimed method alerts 303 an administrator and the user 405 of any content not suitable for public viewing. This content-proofing feature can also be utilized to ensure that a user 405 is not uploading the same advertisement under a different name and/or user name in an attempt to undermine the freshness and non-monopolization goals described herein. The claimed method uses algorithms and proxy servers to scan 304 for duplicate images from different users using the same Internet Protocol address. The claimed method uses a point-based algorithm for detecting and discovering content within user-uploaded images. The claimed method compiles a repository of images. When comparing images, the claimed method assigns points for the common elements of the image. The claimed method will make the duplication determination based on a cumulative point-score. Once a score reaches a threshold amount, the claimed method will alert 305 an administrator and the user of duplicate content.

The invention is also novel because of its ability to broadcast over multiple mediums and display units of all sizes. Said user 405 may select 306 a medium or mediums for displaying said advertisement. For example, using an image rendering unit, the claimed method can turn a tablet into a display unit and immediately send advertising content to said tablet. The claimed method allows the user 405 to upload various image files (for example and without limitation, .jpg, .png, .gif, or .bmp) and then adjusts 307 them to fit on the user-selected medium. For example, a user 405 may upload a 1400×1400-pixel photo for display unit 4304, which the system will automatically adjust to fit the size of the medium for said display unit 4304. Additionally, the user 405 could use said photo for another display unit that measures at 700×700 pixels, and the same adjustment process would occur. Also, the system will allow an embed code from self-service video platforms. The claimed method can display the advertisement photo for the specified time interval.

Once the user 405 chooses 308 to publish uploaded content, the claimed method can immediately publish the content without technical lag time. In addition, the claimed method allows users to view 309 a sample of the advertisement before it is posted online.

Users 405 can specify 310 the geographic locale for displaying of an advertisement. The claimed method is technologically unique as a self-service platform that enables a user 405 to transmit an advertisement to live display unit boards that range in size, style, and shape. Display mediums can include smart phones, tablets, or any mobile device with internet connectivity, small- to jumbo-size display units alike. Once the user 405 specifies the locale and medium, the claimed method transmits 311 the advertisement for display.

In addition, the user 405 will have an interactive map image of the selected display unit 4304 or displays in which the advertisements will be featured. The map is generated 312 by the latitude and longitude coordinates provided by the address of the display unit 4304 or displays. Thus, the user 405 will be able to view 313 the interactive map image based on the coordinates. In an alternative embodiment, administrators would be able to arbitrarily select 314 an advertisement for display on the home page of the website TimePost TV. The advertisement was posted on the home page of the TimePost.TV website would be 315 clickable and would point to the desired URL of a given advertiser. For an advertisement posted on the website's home page, the cost per tic 316 would be $0.01 per second. This equates to $0.15 CPT total for each 15-second Tic, a $0.30 CPT total for each 30-second Tic, and a $0.60 CPT total for each 60-second Tic. This concludes 317 one operation of the claimed method.

FIG. 4 refers to a flowchart for method 500. At step 502, the input feed is received from the user 405. On the basis of various input parameters, smart contracts 4303 are generated at step 504.

At step 506, the method allows the user 405 to select a time slot to display an advertisement. At step 508, the smart contracts 4303 check for available time-slots. If the user 405 preferred time slot is available, a cost for the said time slot is calculated at step 512. The system then provides a unique address to the user 405 for making payment for the time slot at step 516.

At step 516, the user 405 uploads the advertisement to the chosen time slot for which payment has been made. Finally, at step 518, the advertisement is displayed.

At step 508, if the user 405 preferred time slot is not available, the system checks for the alternative slot.

Blockchain is now integrated as a key value-add into the platform. The platform programmatically integrates NFC (Near Field Communication) and Bluetooth technologies into various types of ordinary artifacts, materials, and substances (e.g., paper, plastic, textiles, vinyl, metal, glass) for the sole purpose of interactive direct mail communications. The entire interactive advertisement supply chain is centrally managed by TimePost Digital Out-of-Home (DOOH) media system, which shall live on a private/public blockchain with permissioned and permissionless access.

The TimePost system primarily functions around the 86400-second cycle, whereby seconds are packaged into 15-second intervals for sale on a digital media network. However, time had no actual measure of monetary value until the advent of the Bitcoin Blockchain. In this way, every 10-minute interval that passes, a new Bitcoin is mined into existence, adding a predictable quantity of value to the world's GDP (roughly $10,000 at the time of writing). In this way, every TIC TOC, or 2-minute interval, can be linked to the value of ⅕th of a single Bitcoin, providing a new opportunity cost metric, and associated inherent value. Thus, every 10-Bitcoin-minutes produces 5 TIC TOCs. The validation process includes interlinking of the purchased time-slots (TIC TOCS) on one or more private and/or public, permissionless, and permissioned blockchains. Digital property owners, purchasers, and sellers act as “nodes” in the system. Using a Proof-of-Post consensus mechanism, these nodes validate every transaction and notifies at least two other nodes, who then repeat this process until a definitive end. Finally, all validated transactions are posted on one or more private or public blockchains.

In a preferred embodiment, a Non-Fungible Token (NFT) is created to lease the ad space for a fixed time, and with the help of smart contract functionality enabled by open blockchains, once the time is completed, the ownership will return to the owner. The purchased TIC TOCS are built on NFT's that primarily leverage the Ethereum Blockchain, which uses the ERC 721 protocol. Data is provided either by a permissioned admin or by direct feed from a private and/or public blockchain or distributed ledger. Permissions can even allow for a Multi-Vendor data delivery functionality, whereby all advertisers who seek to lease ad space, can do so via the TimePost System and Method for Advertising Mobile or Web App. As a result of this, the efficiency is significantly optimized, as unused TIC TOCs, can now be used not only to repurchase future ad time on available digital properties, but can be traded on first, second, and third-party digital asset exchanges. TIC TOCS can then be converted into any available crypto or fiat currency. The system recognizes the new attributes of a distributed and decentralized data storehouse as a key benefit and value driver for user adoption and thus allows users to self-manage their advertisements similarly to an asset portfolio in financial markets. The net effect of the system creates an integrity-based economy provided by data transparency, accountability, and immutability.

Exchange A user 405 purchases a TIC or TOC. It goes through a “tokenization” process, whereby the system automatically and autonomously creates a digital token/NFT or coin representing the total value of the financial transaction. The NFTs are secured by cryptography and stored on the platform or a digital or crypto wallet. Unused TIC TOC coins or tokens can be traded and/or converted into an option of fiat and cryptocurrencies. Expired TIC TOC coins or tokens can be converted into their inherent value and then traded and/or converted into an option of fiat and cryptocurrencies. In addition, the system can accept native tokens or coins as a payment for scheduled advertisement campaigns or any other cryptocurrency on the open market.

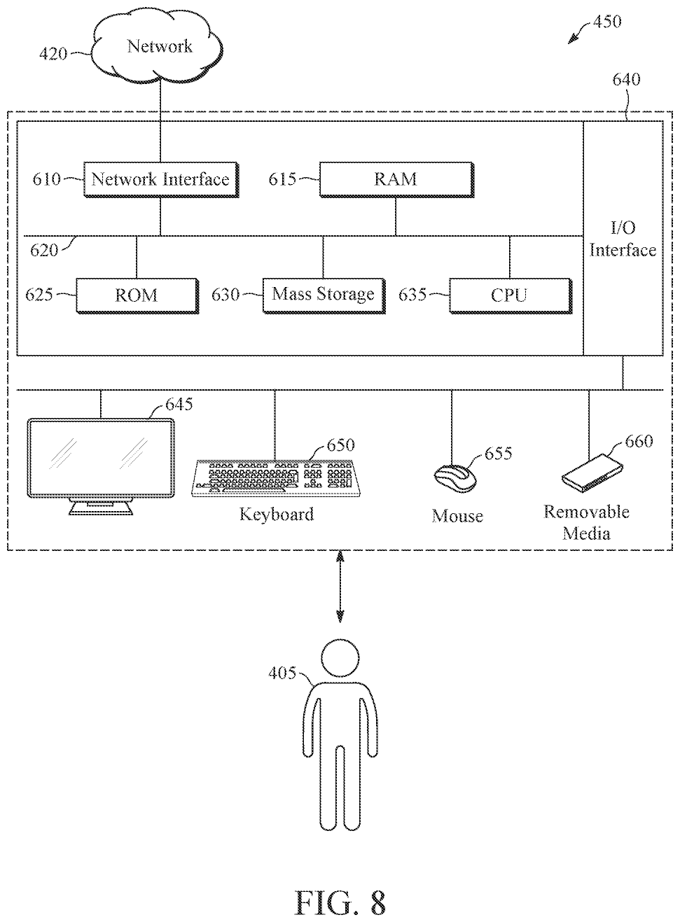

FIG. 8 represents the configuration of the user's computing device 450 being used by a user 405. The said architecture comprises a network interface 610, a Random Access Memory (RAM) 615, a Read-only Memory (ROM) 625, a Mass Storage 630, a Central Processing Unit (CPU) 635, and an I/O (input/output) interface 640. The I/O interface 640 is further coupled with a display unit 645, a keyboard 650, a mouse 655, and a removable media 660. The said computing device 450 is connected to the communication network 420 with the help of network interface 610. These should not be taken as a limitation of the disclosed computing device 450 as there may be additional components in the architecture.

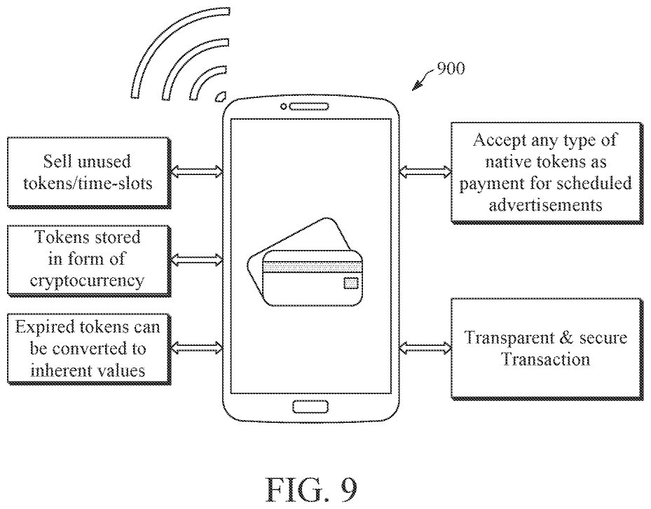

Benefits FIG. 9 provides a pictorial representation depicting the benefits of the present invention. Some of the main benefits of these improvements include a faster buying process, decentralized advertising, increased censorship control for media owners, increased transparency for advertisers, immutability of data (append-only transactions). However, another key benefit is increased security due to cryptographic encryption methods afforded by DLT integration. Historically, bad actors have successfully hacked the digital media properties of the display unit and billboard owners and replaced original creatives with offensive and graphic content, otherwise unauthorized to be displayed in public. Cryptographic encryption provided by DLTs allows digital property owners to have peace of mind knowing that properties can be self-controlled, managed, and mitigated. In addition, the present system uses API to communicate with external private and public blockchains such as the Bitcoin Blockchain, which has never been hacked since its creation in 2009. The TimePost System & Method accomplishes this feat by incorporating free and open-source code provided by the system, such as the Bitcoin Blockchain, and thus inherits all of the military-grade security that benefits all societies.

In a preferred embodiment, the Ethereum blockchain is a suitable network for the TimePost System and method due to its smart contract capability. Essentially, smart contracts 4303 are self-executing programs on the blockchain that perform a predetermined action once all the specified conditions are met. As such, the TimePost method is hard coded in the Ethereum blockchain through smart contracts 4303 to ensure advertisements run as programmed, provided the publisher has met the requirements outlined in the system.

The smart contract 4303 ensures the system runs autonomously as all submissions are made on the TimePost blockchain-based application. For instance, all the time slots for each specific date are assigned codes integrated into the smart contract 4303, allowing publishers to book such slots when submitting their adverts. The platform also integrates APIs that enable users 405 to query the system if the preferred time slots are available. If they are not available, the system could also potentially provide alternative slots that are open based on the advertiser's needs.

Additionally, the price for each time slot will be specified in their code, enabling the platform to compute the total cost for the users based on the type of information input in smart contract 4303. The user 405 will then be provided with a unique address to pay for their advert, upon which the system will generate an acknowledgment receipt. This will only occur if the client has given all the necessary information, paving the smart contract to self-execute. Once this process is completed, the chosen time slot will be locked, meaning it will not be available going forward. Payment for advertising can be made using the native cryptocurrency (TIC TOC) or other supported coins on the platform.

Storage The TimeSpot System also relies on a decentralized file storage system. Ad files are stored on cloud storage networks like Storj, Sia, Filecoin (or own IPFS iteration) with TimePost System using cross-chain bridges to retrieve the files and publish them during the specific time slot. The publishers pay storage fees in select currencies for the time file is stored on the network, which proceeds to incentivize storage providers. Publishers can choose to keep the files on the network after the ad airs, for a fee, or use them at a later date. If no specifications are provided by the publisher/author, the files are automatically deleted after a specified number of days to free up space on the network and avoid wastage of resources like electricity and disk space storing unnecessary files.

Owners have complete control over files and permissions over sharing, access, editing, etc. Blockchain-based cloud storage ensures the security of all ad data as the files are not kept in central servers that are more prone to hacks and security breaches. Decentralized file storage coupled with blockchain' s cryptographic encryption protects the file from being accessed by unauthorized parties. It also provides an incentive mechanism for rewarding the network participants for their storage space and combined contributions to ensuring information safety. Rewards can be issued in the native cryptocurrency or other supported coins on the platform.

As aforementioned, blockchain integration in the TimePost System improves its efficiency by making the process of placing ads autonomous. Smart contracts 4303 helps automate this process by assisting publishers to easily book slots, submit the ad files, and make payments. This process can be made even simpler by developing a great UI/UX design for the TimePost app that eliminates the need for users to interact with the blockchain, which can be quite technical and complex for ordinary people. Instead, the users 405 will be required to fill in the requisite information like time-slot, target audience, host, and platform/website among other preferences through an easy-to-use and interactive app interface. The system will then combine these inputs to create a smart contract 4303 on the Ethereum blockchain and proceed to execute it once payment and all other conditions are fulfilled. This will significantly decrease the advertising processing bottleneck by making the process simpler, more efficient, and convenient.

Automation of the process will also remove middlemen, making advertising much cheaper for publishers and more cost-effective for the entire ecosystem. Most importantly, blockchain integration will help break the monopolization of advertising by big organizations with enormous marketing budgets. The TimePost System employs a novel invention that breaks down advertising using attributes of a standard time clock. It allows anyone to visit a website, purchase a fixed length of time (typically from 15 seconds to 6 minutes) to represent the duration of one period of display of an advertisement, and specify the frequency of periods of display of the advertisement within allowed parameters. The system and method maintain the freshness of advertisements by limiting one particular advertisement to be displayed only once per period.

These rules can be effectively implemented on the blockchain and enforced through smart contracts 4303. They can be hard coded to limit the number of slots specific users can purchase over a given duration on a given platform. This can be achieved through an address whitelisting process for publishers, especially those seeking to buy more advertising. In addition, the platform can install punitive measures to discourage users from breaking the rules and even considerations for AI integration to help weed out offenders. This approach will significantly democratize the advertising process making it more accessible to all interested publishers, not only those with huge budgets.

The foregoing descriptions of specific embodiments of the present invention have been presented for purposes of illustration and description. They are not intended to be exhaustive or to limit the present invention to the precise forms disclosed. Many modifications and variations are possible in light of the above teaching. The embodiments were chosen and described to explain the best principles of the present invention and its practical application and enable others skilled in the art to best utilize the present invention and various embodiments with various modifications suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

What is claimed is:

1. A method for displaying an advertisement on a display unit using an application stored in a computing device which is operated by a user, wherein said application is in communication with a blockchain framework via a communication network, the method comprising the steps of:
accessing the blockchain framework by creating an account in said application;
receiving an input from the user via the application, wherein the input includes a set of information related to the said advertisement;
searching a preferred time slot provided in a coded form in a smart contract for displaying the advertisement, wherein the smart contract is stored in the blockchain framework and comprising a plurality of time slots in a form of ‘tic’ and ‘toc’;
selecting the preferred time slot out of the plurality of time slots when it is available for booking, if already booked, then application provides a list of alternate time slots which are available for booking;
calculating a cost of the preferred time slot via a calculation unit provided within said blockchain framework;
paying the cost of the preferred time slot in a form of virtual currency and fiat currency;
validating a payment through a plurality of nodes of a blockchain of the blockchain framework;
displaying the advertisement on the display unit when a plurality of conditions of said smart contract is fulfilled by an owner of the display unit and the user of the computing device;
monitoring the advertisement in real-time via said application running on the computing device; and
wherein said application is communicably coupled to a server includes a receiving unit for receiving the input from the user, and the blockchain framework for booking a time slot for advertisement.

2. The method as claimed in claim 1, wherein the computing device of the user includes but is not limited to a smartphone, notebook, tablet, laptop, personal computer, personal digital assistant (PDA).

3. The method as claimed in claim 1, wherein ‘tic’ refers to the advertisement on a given digital advertising medium for a specific duration, and ‘toc’ refers to one complete set of advertisements that fill a durational period.

4. The method as claimed in claim 1, wherein the set of information includes but is not limited to size, duration, format, quality of the advertisement.

5. The method as claimed in claim 1, wherein the plurality of time slots is coded in cryptocurrency.

6. The method as claimed in claim 1, wherein said plurality of nodes includes but is not limited to digital property owners, purchasers, sellers.

7. The method as claimed in claim 1, wherein the calculation unit provides a unique address to the user for the payment of the preferred time slot, and this unique address can accept the payment in the form of virtual currency as well as the fiat currency.

8. The method as claimed in claim 1, wherein the application allows the user to set rules/requirements including Geographic address, target audience, age group, target platform, and the like for the advertisement.

9. The method as claimed in claim 1, wherein the application includes a programming code that allows the user to select at least one display unit for displaying the advertisement and modifies a media file of the advertisement in accordance with the display unit.

10. The method as claimed in claim 9, wherein said programming code allows the user to specify geographic locale or locales of the display unit.

11. The method as claimed in claim 9, wherein said programming code allows the advertisement to be transmitted from the computing device of said user to said server.

12. The method as claimed in claim 9, wherein said programming code generates map coordinates of said geographic locale or locales of said display unit.

13. The method as claimed in claim 9, wherein said programming code displays an image of geographic locale or locales with map coordinates to said user.

14. A non-transitory computer-readable medium having computer-executable program instructions which, when executed by a computing device with one or more processors, cause said computing device to perform plurality of instructions:
receiving input feed from a user;
searching a preferred time slot for displaying an advertisement;
selecting the preferred time slot out of a plurality of time slots;
suggesting an alternative time slot when said preferred time slot is not available;
calculating a cost for the preferred time slot which is booked by the user;
validating a payment through a plurality of nodes in a network; and
monitoring the advertisement in real-time.
